(19) United States
(12) Patent Application Publication
(10) Pub. No.: US 2024/0026085 A1
(43) Pub. Date: Jan. 25, 2024

(54) BIODEGRADABLE POLYSILOXANES

(71) Applicant: FRAUNHOFER-GESELLSCHAFT ZUR FÖRDERUNG DER ANGEWANDTEN FORSCHUNG e. V., Munich (DE)

(72) Inventors: Patricia Kuntner, Wurzburg (DE); Peer Löbmann, Wurzburg (DE); Jürgen Clade, Wurzburg (DE); Gerhard Schottner, Wurzburg (DE)

(21) Appl. No.: 18/224,216

(22) Filed: Jul. 20, 2023

(30) Foreign Application Priority Data
Jul. 21, 2022 (DE) 10 2022118294.0

(51) Int. Cl. C08G 77/12; C08G 77/04; C08G 77/38; C08G 77/08; C08K 11/00

(52) U.S. Cl. CPC C08G 77/12; C08G 77/045; C08G 77/38; C08G 77/08; C08K 11/00; C08G 2230/00

(57) ABSTRACT

The present invention relates to cross-linked polysiloxanes containing organic bridging groups Ver, a method for preparing said cross-linked polysiloxanes, blends containing said polysiloxanes and fillers, a method for biobased degradation of said polysiloxanes, the use of the organic bridging groups Ver, the precursors of which contain non-terminal functional groups and/or heteroatoms, in the cross-linked polysiloxanes for the biobased degradation of the cross-linked polysiloxanes by means of a biobased agent, and the use of the cross-linked polysiloxanes and the blend for industrial applications.

### CROSS REFERENCE TO RELATED APPLICATION(S)

The present invention claims priority to German Patent Application No. 10 2022 118 294.0 filed on Jul. 21, 2022, the entire contents of which are incorporated in its entirety.

### FIELD OF THE INVENTION

The present invention relates to cross-linked polysiloxanes containing organic bridging groups, a method for preparing said cross-linked polysiloxanes, mixtures containing said polysiloxanes and particles, a method for biobased degradation of said polysiloxanes, the use of the organic bridging groups Ver, the precursors of which contain non-terminal functional groups and/or heteroatoms, in the cross-linked polysiloxanes for the biobased degradation of the cross-linked polysiloxanes by means of a biobased agent, and the use of the cross-linked polysiloxanes and the mixture for industrial applications.

### TECHNICAL BACKGROUND

Polysiloxanes (also known as silicones) are polymeric organosilicon compounds that are composed of an inorganic backbone of alternating silicon and oxygen atoms. Two organic groups are usually bonded directly to the silicon atoms via carbon atoms.

Due to this structure, polysiloxanes are characterized by outstanding, partly unique properties and at the same time distinguish themselves from other synthetic plastics. Special properties of the silicones are, for example, their high thermal stabilities, but a long service life is also characteristic of this class of materials. Conversely, however, this means that polysiloxanes are not biodegradable or even degradable. Moreover, polysiloxanes do not occur in nature, but are purely synthetically produced substances.

A distinction must be made between biobased and biodegradable polysiloxanes. Biobased systems include polysiloxanes in combination with polyesters, for example, which are usually block copolymers. There is as yet no described solution to the problem of biodegradable polysiloxanes.

WO 2021/190737 A1 reports on polyester-polysiloxane copolymers. These are merely copolymers in which alternating polyester chain segments are linked with polysiloxane chain segments. Moreover, the concept of (bio)degradation is not found in this patent.

WO 2022/019179 A1 also reports on a copolymer of polyester-organopolysiloxanes. Here, the concept of (bio)degradation is also not found. The degradation works due to the functional groups in the particles in a humid environment. The inventors of patent WO 2022/019179 A1 conclude, based on the polyester structure in the particles that degradation can occur in the environment. However, this is again a copolymer with relatively long polyester chain segments. The same is true of US 2020/362116 AA. It reports a polysiloxane-polyester block copolymer, although here the concept of (bio)degradation does not play a role.

US 2016/160011 A1 describes the production of an RTV silicone (RTV=room temperature vulcanizing), which reacts with the help of moisture from the environment as a catalyst.

Starch and another biopolymer, which is biodegradable, are added to this in the manufacturing process. However, this is a polymer mixture and the biodegradability does not exist for the silicone component, but only for the starch component and other already known biodegradable biopolymers (cellulose derivatives, for example, are mentioned in the patent specification).

A high amount of an already known biodegradable biopolymer also underlies CN 111286177 A. Although a small amount of a polysiloxane-polyimide copolymer can be found in the composite material (12 to 16 parts), the (bio)degradation is achieved by the high amount of PLA (PLA=polylactic acid; 80 to 85 parts).

WO 2017/191603 A1 describes a copolymer of PLA, which is known as a biodegradable polymer, and silicone.

WO 2021/005267 A1 deals with a hybrid polymer comparable to ORMOCER® en. This is a hybrid polymer composite of a metal oxane prepolymer/monomer and a biopolymer, such as PHB (PHB=polyhydroxybutyrate). Due to the use of biopolymers, the concepts of bio-based, recyclable polymers as well as biodegradation play a role in this patent specification.

However, composites using biopolymers (i.e. macromolecules) are described here.

US 2021253901 AA describes various methods for biodegradable coatings. According to this patent specification, paper is coated with a reaction product of an amino-functionalized polymer (e.g. chitosan) with an amino-reactive functionalized “omniphobic” polymer (e.g. epoxidized PDMS). Biodegradability is achieved here by already known biodegradable polymers, such as chitosan.

CN 113372594 A deals with a blend consisting of PBAT (PBAT=polybutylene adipate terephthalate) based degradable plastic mixed with PE (PE=polyethylene) and modified polysiloxane. The task of the polysiloxane is to improve the compatibility between PBAT and PE, i.e. it is a polymer mixture and not a uniform material.

CN112375343 A describes a plastic whose main component is polydiheptyl succinate, with the addition of polysiloxane fluids serving to extend the service life of the plastic. It is therefore also a polymer blend.

WO 2022/019179 A1 describes particles composed of a copolymer of polyester and organopolysiloxanes.

U.S. Pat. No. 7,786,241 B2 describes a polysiloxane polyester prepared by transesterification of a polysiloxane terminally substituted with a carboxylic acid ester and a carbinol-terminated silicone. The applicants of U.S. Pat. No. 7,786,241 B2 argue that the ester moiety increases biodegradation. However, the polysiloxanes described there are block copolymers in which chains without cross-links are present in the polysiloxane sections.

In the state of the art, insufficient solutions are known on how to recycle, degrade and compost polysiloxanes by biobased degradation.

The present invention is based on the basic idea of linking polysiloxane chains with small molecular units as bridging groups to form polysiloxane networks, which contain individual linkage points as “predetermined breaking points” for biobased degradation.

The cross-linked polysiloxanes of the invention can be degraded by biobased agents such as enzymes or microorganisms by attacking and degrading the linkage molecules into their parent substances, which are then available for further applications.

### SUMMARY OF THE INVENTION

The present invention relates to cross-linked polysiloxanes containing the following general structural feature.

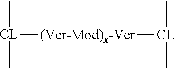

wherein
CL is a so-called “cross-linker” unit, which contains a polysiloxane chain with the basic structure according to formula (I)

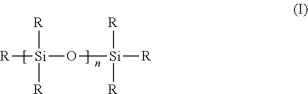

or a polysiloxane ring having the basic structure according to formula (II)

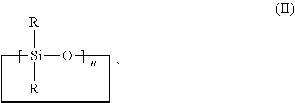

wherein
   R is independently selected from a linear, cyclic or branched, aliphatic or aromatic, saturated or unsaturated hydrocarbon group having from 1 to 20 carbon atoms, optionally containing heteroatoms selected from O, N, S or P, —H or —O—R′,
   R′ is a polysiloxane chain or a polysiloxane ring having the basic structure according to formula (I) or formula (II), respectively, and
n is a numerical value from 0 to 1000000 in the case of polysiloxane chains according to formula (I), and a numerical value from 2 to 1000000 in the case of polysiloxane rings according to formula (II),
   and the precursor of each CL unit contains three or more functional groups that form covalent bonds with terminal functional groups of precursors of bridging groups;
Ver is an organic bridging group whose precursor(s) contain functional groups and/or heteroatoms and at least two terminal functional groups, wherein the at least two terminal functional groups each form a covalent bond with a functional group of a cross-linker precursor or a functional group of a modifier precursor, if present;
Mod are one or more modifier group(s) whose precursor(s) are siloxanes or polysiloxanes containing two terminal functional groups each forming a covalent bond with a terminal functional group of the bridging precursor(s); and
x is a numerical value from 0 to 20.

Further, the present invention relates to a method for preparing the cross-linked polysiloxanes as described herein, comprising the following steps:
Providing one or more polysiloxanes having polysiloxane chains or polysiloxane rings, which act as a cross-linker unit CL, having the basic structure according to formula (I) or formula (II), respectively;
Providing one or more precursors of the organic bridging group(s) Ver;
Optionally providing one or more precursors of the modifier group(s) Mod;
Optionally covalently linking a terminal functional group of one or more precursors of Ver to a functional group of one or more precursors of Mod in the presence of one or more catalysts and optionally in the presence of one or more inhibitors to produce the optional structure (Ver-Mod)ₓ-Ver;
Covalently linking a respective functional group of the precursor(s) of the cross-linker unit CL, to a respective terminal functional group of the precursor(s) of Ver and/or optionally of (Ver-Mod)ₓ-Ver in the presence of one or more catalysts and optionally in the presence of one or more inhibitors.

In addition, the present invention relates to a blend comprising cross-linked polysiloxanes as described herein and fillers, such as particles, fibers, fiber mats, flakes, additives, catalysts and mixtures thereof.

Further, the present invention relates to a method for biobased degradation of cross-linked polysiloxanes as described herein comprising the following steps:
Providing a cross-linked polysiloxane as described herein;
Mixing the cross-linked polysiloxane with a biobased agent that cleaves the cross-linked polysiloxane at least at the location of the functional groups and/or heteroatoms of the one or more organic bridging groups Ver.

Further, the present invention relates to the use of one or more organic bridging groups Ver, the precursor(s) of which contain one or more non-terminal functional groups and/or heteroatoms and at least two terminal functional groups, in the cross-linked polysiloxane as described herein for biobased degradation of the cross-linked polysiloxane by means of a biobased agent, such as microorganisms, preferably bacteria, fungi or algae, or enzymes outside living organisms.

Lastly, the present invention relates to the use of the cross-linked polysiloxanes and the blend as described herein for industrial applications, such as in the chemical industry, rubber and plastics industry, construction industry, automotive sector, electrical and electronics industry, paper industry, and others.

### Definitions

Biodegradable polymers are polymers that are decomposed by microorganisms, such as bacteria or fungi, by means of enzymes under suitable conditions, for example into CO₂, water, inorganic components such as SiO₂ and biomass. The relevant conditions are defined in standards such as the EU standard EN 13432 or the US standard ASTM 6400. Complete biodegradation can occur in four steps: 1. biological decomposition, 2. depolymerization, 3. assimilation, 4. mineralization.

“Biobased” means based on biological agents. This includes naturally occurring agents such as renewable raw materials or microorganisms. Examples include biobased polymers such as cellulose acetate, which is obtained from cellulose, or biobased catalysts such as enzymes, which are extracted from microorganisms or cell cultures, for example.

“Degradation” in the sense of the present invention means a chemically or biologically induced decomposition of a molecular compound, in this case of the cross-linked polysiloxanes according to the invention. In addition to a complete biological decomposition (up to the step of mineralization), smaller units of the molecular compounds can also be obtained already in the first step of the biological decomposition, which in turn can be recycled and reused for the production of new products.

### DETAILED DESCRIPTION OF THE INVENTION

Cross-Linked Polysiloxanes

In a first aspect, the present invention relates to cross-linked polysiloxanes containing the following general structural feature.

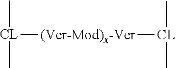

wherein
CL is a so-called “cross-linker” unit, which contains a polysiloxane chain with the basic structure according to formula (I)

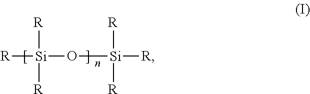

or a polysiloxane ring having the basic structure according to formula (II)

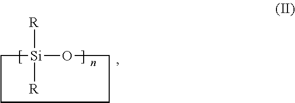

wherein
   R is independently selected from a linear, cyclic or branched, aliphatic or aromatic, saturated or unsaturated hydrocarbon group having from 1 to 20 carbon atoms, optionally containing heteroatoms selected from O, N, S or P, —H or —O—R′,
   R′ is a polysiloxane chain or a polysiloxane ring having the basic structure according to formula (I) or formula (II), respectively, and
   n is a numerical value from 0 to 1000000 in the case of polysiloxane chains according to formula (I), and a numerical value from 2 to 1000000 in the case of polysiloxane rings according to formula (II),
   and the precursor of each CL unit contains three or more functional groups that form covalent bonds with terminal functional groups of precursors of bridging groups Ver;
Ver is an organic bridging group whose precursor(s) contain functional groups and/or heteroatoms and at least two terminal functional groups, wherein the at least two terminal functional groups each form a covalent bond with a functional group of a cross-linker precursor or a functional group of a modifier precursor, if present;
Mod are one or more modifier group(s) whose precursor(s) are siloxanes or polysiloxanes containing two terminal functional groups each forming a covalent bond with a terminal functional group of the bridging precursor(s); and
x is a numerical value from 0 to 20.

A cross-linker unit CL independently contains a polysiloxane chain or a polysiloxane ring having the basic structure according to formula (I) or formula (II), respectively.

In general, polysiloxanes have the following siloxane units, which are designated as mono-, di-, tri- or tetrafunctional and correspondingly as M, D, T or Q. The general structure of these siloxane units is given below.

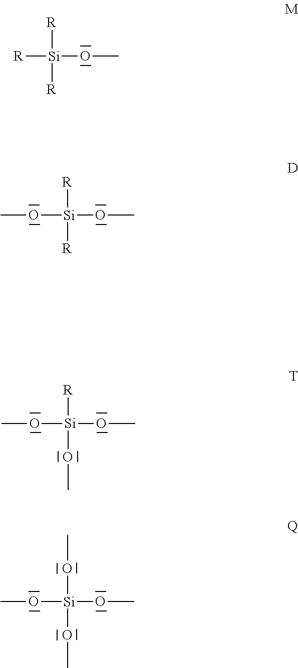

The polysiloxanes of the general formula (I) or (II) can be linear, cyclic, branched or already cross-linked polysiloxanes.

Linear polysiloxanes (polysiloxane chains) have a structure of siloxane units according to the MDₘ M pattern and usually accumulate as oils.

Cyclic polysiloxanes have a structure of siloxane units following the pattern Dₘ.

Branched polysiloxanes have a structure of siloxane units according to the pattern MₙDₘTₒQₚ.

In this case, the branches are inserted into the polysiloxane chains by the tri- and/or tetrafunctional siloxane units T and/or Q.

In cross-linked polysiloxanes, linear, branched or ring-shaped polysiloxanes are linked via a large number of tri- and/or tetrafunctional siloxane units T and/or Q to form two- or three-dimensional networks.

The group R in the general formula (I) or (II) is independently selected from a linear, cyclic or branched, aliphatic or aromatic, saturated or unsaturated hydrocarbon group having 1 to 20 C-atoms, optionally containing heteroatoms selected from O, N, S or P, or —H or —O—R′.

In the case of a hydrocarbon group, R is preferably a linear or branched, more preferably a linear hydrocarbon group.

Further, in this case, R is preferably an aliphatic saturated or unsaturated, more preferably a saturated hydrocarbon group.

Preferably, the hydrocarbon group has 1 to 12 C-atoms, more preferably 1 to 8 C-atoms, even more preferably 1 to 4 C-atoms.

Via heteroatoms such as O, N, S or P, functional groups can be inserted into the hydrocarbon group such as ester groups, ether groups, alkoxy groups, carboxy groups, acetoxy groups, amino groups, amido groups, imino groups, oxime groups, glycoside groups, urethane groups, thiourethane groups, thioether groups or thiol groups.

In formula (I), n is a numerical value in the range of from 0 to 1000000, preferably from 1 to 5000, more preferably from 5 to 1000, even more preferably from 10 to 500.

In formula (II), n is a numerical value in the range of from 2 to 1000000, preferably from 4 to 5000, more preferably from 10 to 1000, even more preferably from 20 to 500.

In a preferred embodiment, the polysiloxanes are linear polysiloxane chains of the general formula (I), wherein R is independently selected from linear saturated and optionally unsaturated hydrocarbon groups having from 1 to 4 carbon atoms and —H.

Polydimethylsiloxane (PDMS), terminal dihydrogenpolydimethylsiloxane and/or hydrogenpolydimethylsiloxanes with side groups R═—H are particularly preferred.

The precursors for the cross-linker units CL contain three or more functional groups that form covalent bonds to the terminal functional groups of the precursors of the bridging groups Ver.

Here, a functional group cross-linker units CL forms a covalent bond with a terminal functional group of a bridging group Ver precursor.

The precursors for the cross-linker units CL contain at least 3, for example 3 to 10, preferably 3 to 6 functional groups that form covalent bonds to the precursors of at least three bridging groups Ver.

In a particularly preferred embodiment, the precursors for the cross-linker units CL contain 3 functional groups that form covalent bonds to the precursors of at least three bridging groups Ver.

In this case, covalent bonding occurs via one of the at least two terminal functional groups of the bridging groups Ver.

The one or more functional groups of the precursors for the cross-linker units CL are preferably selected from the group consisting of —Si—H groups, hydroxy groups, alkoxy groups, carboxy groups, epoxy groups, isocyanate groups and oxime groups. —Si—H groups are particularly preferred.

The polysiloxanes according to the invention contain one or more, for example 1 to 10, preferably 1 to 3 different, but most preferably only one type of cross-linker units CL.

The precursor(s) of the cross-linker(s) CL are preferably selected from the group of hydrogenpolysiloxanes.

Precursors for the CL cross-linker units can either be prepared via standard polymerization reactions or are commercially available.

Polysiloxane cross-linker precursors, such as hydrogenpolydimethylsiloxanes of various chain lengths, which are commercially available, for example, from Evonik Industries under the name “Cross-linker 100/200 Series”, are suitable.

The polysiloxanes according to the invention are composed of covalent bonds between cross-linker units CL, one or more bridging groups Ver and optionally one or more modifier groups Mod.

Via one or more bridging groups Ver and optionally one or more modifier groups Mod, the cross-link between the cross-linker units CL is established.

As discussed above, the cross-linked polysiloxane may contain other cross-links in addition to those introduced via the bridging groups. These cross-links are preferably introduced into the cross-linked polysiloxane through the use of already cross-linked polysiloxanes.

In contrast to conventional cross-links of polysiloxanes as known in the prior art, the bridging groups Ver as described herein possess at least in their non-terminal functional groups and/or heteroatoms points of attack for cleavage of the cross-links of the cross-linked polysiloxane.

The polysiloxanes according to the invention further contain one or more, for example 1 to 10, preferably 1 to 4, more preferably 1 or 2, most preferably 2 bridging groups Ver per structural unit

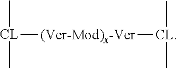

x is a numerical value from 0 to 20, preferably 1 to 20. The most preferred is x=1.

The bridging group(s) Ver are organic groups whose precursor(s) contain one or more, for example 1 to 10, preferably 1 to 4, more preferably 1 or 2, most preferably 1 non-terminal functional groups and/or heteroatoms.

Furthermore, the precursor(s) of the bridging groups Ver contain at least two, for example 2 to 10, preferably 2 to 6, more preferably 2 to 4, most preferably two terminal functional groups.

Two terminal functional groups of the precursor(s) of the bridging groups Ver can introduce a linear cross-linking between the cross-linker units CL into the polysiloxane according to the invention.

By having more than two terminal functional groups of the precursor(s) of the bridging groups Ver, a branched cross-linking between the cross-linker units CL is introduced into the polysiloxane according to the invention.

Linear cross-linking is preferred.

The terminal functional groups of the precursor(s) of Ver must be capable of forming a covalent bond with each of a functional group of the precursor(s) of the cross-linker unit CL and/or a functional group of the precursor(s) of the modifier group Mod, if present.

Suitable terminal functional groups are preferably independently selected from the group consisting of linear or branched unsaturated hydrocarbon groups having 2 to 10 C-atoms and terminal C═C double bond such as vinyl groups, allyl groups or vinylidene groups, alkoxy groups, carboxy groups and oxime groups.

The non-terminal functional groups of Ver are preferably selected from the group consisting of esters, imines, ethers, thioethers, ketones, amides, urethanes, thiourethanes and glycosides.

The heteroatoms are preferably selected from the group consisting of oxygen, nitrogen, sulfur and phosphorus.

Preferred precursors for Ver include phthalic or terephthalic acid diallyl esters, α,ω-unsaturated esters of fatty acid and fatty alcohol or phenols from essential oils such as eugenol, mono-, di- or generally oligoethylene glycol divinyl or allyl ethers and diallyl carbonate.

The precursor(s) for the Ver bridging groups can be bio-based, natural product-based or synthetic.

The polysiloxanes according to the invention may contain one or two or more, for example 1 to 10, preferably 1 to 4, more preferably 1 or 2 different bridging groups Ver, most preferably 2 bridging groups Ver per bridge between two CL units.

In the polysiloxanes according to the invention, the cross-linker units CL can be cross-linked either with single bridging groups Ver or with chains of bridging and modifier groups (Ver-Mod)ₓ-Ver.

Modifier groups Mod are preferably used to extend the chain length of the bridges and thus modify the properties of the cross-linked polysiloxane.

The precursor(s) of the modifier group(s) Mod are preferably polysiloxanes with two terminal functional groups.

The functional groups of the precursor of the modifier are preferably selected from the group consisting of Si—H groups, hydroxy groups, alkoxy groups, carboxy groups, epoxy groups, isocyanate groups, and oxime groups.

The polysiloxanes according to the invention may contain no or one or more, for example 0 to 10, preferably 0 to 4, more preferably 0 or 1 modifier groups Mod, most preferably one modifier group Mod per bridge between two CL units.

The precursor of each CL unit forms covalent bonds to at least three, for example 3 to 10, preferably 3 to 6, more preferably 3 or 4, most preferably 3 precursors of bridging groups Ver. This means that each precursor of each CL unit forms cross-links to other precursors of CL units via at least 3, for example 3 to 10, preferably 3 to 6, more preferably 3 or 4, most preferably 3 covalent bonds to precursors of bridging groups Ver.

Process for the Preparation of the Cross-Linked Polysiloxane According to the Invention

In another aspect, the present invention relates to a method for preparing the cross-linked polysiloxanes as described herein comprising the following steps:
Providing one or more polysiloxanes having polysiloxane chains or polysiloxane rings, which act as a cross-linker unit CL, having the basic structure according to formula (I) or formula (II), respectively;
Providing one or more precursors of the organic bridging group(s) Ver;
Optionally providing one or more precursors of the modifier group(s) Mod;
Optionally covalently linking a terminal functional group of one or more precursors of Ver to a functional group of one or more precursors of Mod in the presence of one or more catalysts and optionally in the presence of one or more inhibitors to produce the optional structure (Ver-Mod)ₓ-Ver;
Covalently linking a respective functional group of the precursor(s) of the cross-linker unit CL, to a respective terminal functional group of the precursor(s) of Ver and/or optionally of (Ver-Mod)ₓ-Ver in the presence of one or more catalysts and optionally in the presence of one or more inhibitors.

In this regard, the polysiloxanes comprising CL, Ver and Mod preferably correspond to all aspects and embodiments of the polysiloxanes, CL, Ver and Mod as described herein.

The catalyst(s) is/are preferably selected from catalysts for hydrosilylation reactions, catalysts for condensation reactions of alkoxy-containing polysiloxanes, catalysts for condensation reactions of carboxy-containing polysiloxanes, and catalysts for condensation reactions of oxime-containing polysiloxanes.

The catalysts are preferably precious metal catalysts, more preferably platinum catalysts. Suitable precious metal catalysts, preferably platinum catalysts are for example Karstedt catalyst, Ashby catalyst, Ossko catalyst and the like.

The inhibitor(s) are preferably selected from suitable inhibitors for hydrosilylation reactions, condensation reactions of alkoxy-containing polysiloxanes, condensation reactions of carboxy-containing polysiloxanes and condensation reactions of oxime-containing polysiloxanes. Suitable inhibitors include maleic acid dimethyl ester, 1-ethynyl-1-cyclohexanol, Inhibitor 600 from the Evonik Industries product line, or the like. Such inhibitors are known for siloxane polymerizations and can also be used in the process according to the invention.

In one embodiment, the formation of the bridging group from the precursors of Ver and optionally Mod and their covalent linkage to the precursors of CL is carried out in one reaction step. For this purpose, the corresponding precursors of CL, Ver and optionally Mod and the catalyst(s) are preferably mixed and allowed to react in a one-pot reaction.

The reaction mixture is preferably in liquid form. For this purpose, the starting substances can be dissolved in a suitable solvent such as butyl acetate or toluene.

The reaction usually takes place at a temperature of 10 to 100° C., preferably 20 to 80° C., more preferably 35 to 70° C.

The reaction time is typically from 1 hour to 100 hours, preferably from 5 hours to 80 hours, more preferably from 12 hours to 72 hours, even more preferably from 24 hours to 60 hours.

Due to cross-linking, the resulting cross-linked polysiloxane cures.

In a further embodiment, the chain length of the bridging group can first be adjusted in a first step by reacting the precursors of Ver and Mod before the obtained intermediate reacts with the precursors of CL in a second step to form the inventive polysiloxane.

For this purpose, in a first reaction step, the precursors of Ver and Mod are first mixed with the catalyst(s) and allowed to react.

The reaction mixture is preferably in liquid form. For this purpose, the starting substances can be dissolved in a suitable solvent such as butyl acetate or toluene.

The reaction usually takes place at a temperature of 10 to 100° C., preferably 20 to 80° C., more preferably 35 to 70° C.

The reaction time is typically from 1 hour to 100 hours, preferably from 5 hours to 80 hours, more preferably from 12 hours to 72 hours, even more preferably from 24 hours to 60 hours.

The intermediate obtained in this first step is mixed with the precursors of CL and the catalyst(s) and allowed to react.

The reaction mixture is preferably in liquid form. For this purpose, the starting substances can be dissolved in a suitable solvent such as butyl acetate or toluene.

The reaction usually takes place at a temperature of 10 to 100° C., preferably 20 to 80° C., more preferably 35 to 70° C.

The reaction time is typically from 1 hour to 100 hours, preferably from 5 hours to 80 hours, more preferably from 12 hours to 72 hours, even more preferably from 24 hours to 60 hours.

The first reaction step can be repeated several times until the desired chain length of the intermediate, which serves as a precursor for the extended bridging group (Ver-Mod)ₓ-Ver, is achieved.

Finally, the obtained intermediate is mixed with the precursors of CL and the catalyst(s) and allowed to react to obtain the polysiloxane of the invention.

The reaction mixture is preferably in liquid form. For this purpose, the starting substances can be dissolved in a suitable solvent such as butyl acetate or toluene.

The reaction usually takes place at a temperature of 10 to 100° C., preferably 20 to 80° C., more preferably 35 to 70° C.

The reaction time is typically from 1 hour to 100 hours, preferably from 5 hours to 80 hours, more preferably from 12 hours to 72 hours, even more preferably from 24 hours to 60 hours.

Due to cross-linking, the resulting cross-linked polysiloxane cures.

In another aspect, the present invention relates to a blend comprising the cross-linked polysiloxane as described herein and fillers, such as particles, fibers, fiber mats, flakes, additives, catalysts, and mixtures thereof.

Suitable particles include aerosil particles, silver-containing particles, copper-containing particles, carbon black particles, boron nitride particles, glass particles, plasticizers such as wax particles or oil particles, particles with a high dielectric constant, particles with a high optical refractive index, magnetic particles and color-imparting particles. These particles can also be used in the form of fibers, fiber mats or flakes.

Preferably, additives are additives for the adaptation of rheology, processability, etc. Such additives are known in the art

In one embodiment, the blend comprises the cross-linked polysiloxane and the fillers.

In another embodiment, the blend contains other components such as additives and/or other polymers.

The weight percentage of the additives in the mixture is usually a maximum of 5 wt.-%.

The weight percentage of the other polymers in the mixture is usually not more than 25 wt.-%.

The weight percentage of particles in the mixture is typically in the range of 0.1 to 50 wt.-%, preferably from 0.5 to 40 wt.-%, more preferably from 1 to 30 wt.-%, even more preferably from 5 to 20 wt.-%.

The weight percentage of the cross-linked polysiloxane in the blend is typically in the range of from 50 to 99.9 wt.-%, preferably from 60 to 99.5 wt.-%, more preferably from 70 to 99 wt.-%, even more preferably from 80 to 95 wt.-%.

The blend is preferably present as a dispersion.

The particles are usually introduced into the blend to change the properties of the cross-linked polysiloxane.

The following properties can preferably be changed by using different particle systems:
Aerosil particles to improve tear strength
Silver nanowires, carbon black particles, copper particles or similar to increase electrical conductivity
Boron nitride or similar to increase thermal conductivity
Glass flakes or similar to reduce water vapor permeability
Plasticizers such as waxes or oils
Particles with high dielectric constant such as BaTiO₃ or similar to increase dielectric permittivity
Particles with high optical refractive index such as ZrO₂ or similar to increase the refractive index
Magnetic particles such as Fe 034 to realize a magnetic composite
color-imparting particles (decor), e.g. Fe₂O₃ or Cu-phthalocyanine

Method for Biobased Degradation of Cross-Linked Polysiloxanes.

In another aspect, the present invention relates to a method for biobased degradation of cross-linked polysiloxanes as described herein, comprising the following steps:
Providing a cross-linked polysiloxane as described herein;
Mixing the cross-linked polysiloxane with a biobased agent that cleaves the cross-linked polysiloxane at least at the location of the functional groups and/or heteroatoms of the one or more organic bridging groups Ver.

All aspects and embodiments of the polysiloxanes of the invention are preferably used herein.

The biobased agent is preferably selected from microorganisms, preferably bacteria, fungi or algae, or enzymes.

Enzymes are preferably selected from the group consisting of the main class EC 3.-.-.- of hydrolases, preferably lipases.

Degradation of the cross-linked polysiloxane preferably occurs in aqueous solution.

The reaction temperature is preferably within the optimal temperature range of the biobased agent, preferably in the range of 20 to 40° C., more preferably at room temperature.

A neutral pH value of the mixture is preferred. However, degradation can also occur in a different pH environment of the mixture.

Degradation of the cross-linked polysiloxane occurs when the biobased agent attacks at least the location of the functional groups and/or heteroatoms of the one or more organic bridging groups.

This biobased agent can be an enzyme, for example a lipase, which cleaves ester groups.

However, other enzymes from the main class of hydrolases (EC 3.-.-.-; especially EC 3.1.-.-.), microorganisms, or the like can also be used for this purpose. The enzymes are preferably derived from microorganisms such as bacteria or (yeast) fungi. It is also essential that the degradation is “triggered”, i.e. only when the conditions required for degradation are deliberately created.

In the method according to the invention, the polymer network is broken up at specific points.

The degradation products obtained in this way can then be recovered to the greatest possible extent.

Likewise, the catalyst, which preferably consists of precious metal compounds, can also be recovered by the process according to the invention.

The aim of the method according to the invention is to recycle the recovered polysiloxane components and, if necessary, also the catalyst into a renewed synthesis process.

The method according to the invention can also be applied to the blends containing particles as described herein.

Use

In another aspect, the present invention relates to the use of one or more organic bridging groups Ver, the precursor(s) of which contain one or more non-terminal functional groups and/or heteroatoms and at least two terminal functional groups, in the cross-linked polysiloxane as described herein for biobased degradation of the cross-linked polysiloxane by means of a biobased agent, such as microorganisms, preferably bacteria, fungi or algae, or enzymes outside living organisms.

Preferably, all aspects and embodiments of Ver, the cross-linked polysiloxane and the biobased degradation method as described herein find application in the use according to the invention.

Further, the present invention relates to the use of the cross-linked polysiloxanes and the blend as described herein for industrial applications, such as in the chemical industry, rubber and plastics industry, construction industry, automotive sector, electrical and electronics industry, paper industry, and others.

Preferably, all aspects and embodiments of the cross-linked polysiloxanes and the blend as described herein find application in the use according to the invention.

The present invention is further illustrated by the following non-limiting examples:

### EXAMPLES

### Example 1: Production of a Biodegradable Silicone

The individual components hydrogenpolydimethylsiloxane (CL 120, Evonik Industries company; 2.36 g, 1.18 mmol/g Si—H), terminal dihydrogenpolydimethylsiloxane (Mod 705, SiH-terminated PDMS, Evonik Industries company; 6.25 g, 0.16 mmol/g Si—H), phthalic acid diallyl ester (Sigma Aldrich company; 0.25 g, 2.0 mmol) and butyl acetate (0.5 g, 4.3 mmol) as well as Aerosil R 8200 as reinforcing agent (Evonik Industries company; 1.79 g; 20 wt.-%) are added to a Speedmix beaker and homogenized in the SpeedMixer™ (SpeedMixer™ DAC 400.1 VAC-P) at 2500 rpm for 1 minute. Next, 0.01 g of Ashby catalyst (ABCR Company; 0.35% in cyclic methylvinylsiloxane) is added to the mixture and homogenized in the SpeedMixer™ (SpeedMixer™ DAC 400.1 VAC-P) at 2000 rpm for 30 seconds. The mixture is then cured in an oven at 60° C. for up to 48 hours.

### Example 2: Production of a Biobased, Biodegradable Silicone

The precursor undec-10-en-1-yl-undec-10-enoate is prepared following Lebarbe et al. 2014. Macromolecular rapid communications, 35(4), 479-483 from methyl 10-undecenoate (Sigma Aldrich Company; 15.00 g; 75.6 mmol) and 10-undecen-1-ol (Sigma Aldrich Company; 12.87 g; 75.6 mmol) with TBD (Sigma Aldrich Company; 1,5,7-triazabicyclo[4.4.0]dec-5-ene; 0.53 g; 3.78 mmol) as the transesterification catalyst.

Alternatively, the preparation can be made from 10-undecenoyl chloride (Sigma Aldrich Company; 3.04 g; 15 mmol), 10-undecen-1-ol (Sigma Aldrich Company; 2.55 g; 15 mmol), and triethylamine (Sigma Aldrich Company; 2.51 mL; 18 mmol) following Le et al. 2019. RSC Advances, 9(18), 10245-10252.

The individual components hydrogenpolydimethylsiloxane (CL 120, company Evonik Industries; 2.36 g, 1.18 mmol/g Si—H), terminal dihydrogenpolydimethylsiloxane (AB109364, SiH-terminated PDMS, company ABCR; 0.36 g, 0.16 mmol/g Si—H), undec-10-en-1-yl-undec-10-enoate (0.34 g, 2.0 mmol), butyl acetate (0.2 g, 1.72 mmol), and Aerosil R 8200 as reinforcing agent (Evonik Industries company; 0.61 g; 20 wt.-%) are added to a Speedmix beaker and homogenized in the SpeedMixer™ (SpeedMixer™ DAC 400.1 VAC-P) at 2500 rpm for 1 minute. Next, 0.01 g of Ashby catalyst (ABCR Company; 0.35% in cyclic methylvinylsiloxane) is added to the mixture and homogenized in the SpeedMixer™ (SpeedMixer™ DAC 400.1 VAC-P) at 2000 rpm for 30 seconds. The mixture is then cured in an oven at 60° C. for up to 48 hours.

### Example 3: Production of a Biodegradable Silicone with Longer Bridge

Step 1: Making the precursor for a bridge (Ver-Mod)ₓ-Ver (x=1)

The individual components phthalic acid diallyl ester (Sigma Aldrich company; 0.25 g; 2 mmol), terminal dihydrogenpolydimethylsiloxane (AB109364, SiH-terminated PDMS, ABCR company; 0.36 g, 0.16 mmol/g Si—H) and butyl acetate (0.2 g; 1.72 mmol) are mixed with 0.01 g Ashby catalyst (ABCR company; 0.35% in cyclic methylvinylsiloxane) and homogenized in the SpeedMixer™ (SpeedMixer™ DAC 400.1 VAC-P) at 2000 rpm for 1 minute. The mixture is then brought to reaction in an oven at 60° C. for up to 48 hours until a highly viscous liquid is obtained.

Step 2: Linking of the precursor of the bridge (Ver-Mod)ₓ-Ver (x=1) with cross-linker The bridge obtained in step 1 (0.61 g; 1.0 mmol) is added to a Speedmix beaker with hydrogenpolydimethylsiloxane (CL 120, Evonik Industries company; 2.36 g, 1.18 mmol/g Si—H) and 0.01 g Ashby catalyst (ABCR company; 0.35% in cyclic methylvinylsiloxane) and homogenized in the SpeedMixer™ (SpeedMixer™ DAC 400.1 VAC-P) at 2000 rpm for 1 minute. The mixture is then cured in an oven at 60° C. for up to 48 hours.

### Example 4: Production of Precursors for Bridges (Ver-Mod)ₓ-Ver (x=1-20) with Adjustable Length

The bridge precursor (0.61 g; 1.0 mmol) prepared according to step 1 of example 3 is added to a Speedmix beaker with terminal dihydrogenpolydimethylsiloxane (AB109364, SiH-terminated PDMS, ABCR company; 0.73 g, 2.57 mmol/g Si—H) and 0.01 g Ashby catalyst (ABCR company; 0.35% in cyclic methylvinylsiloxane) and homogenized in the SpeedMixer™ (SpeedMixer™ DAC 400.1 VAC-P) at 2000 rpm for 1 minute. The mixture is then brought to reaction in an oven at 60° C. for up to 48 hours until a highly viscous liquid is formed.

The resulting product (1.34 g; 1.0 mmol) is added to a Speedmix beaker with diallyl phthalate (Sigma Aldrich Company; 0.25 g, 2.0 mmol) and 0.01 g Ashby catalyst (ABCR Company; 0.35% in cyclic methylvinylsiloxane) and homogenized in the SpeedMixer™ (SpeedMixer™ DAC 400.1 VAC-P) at 2000 rpm for 1 minute. The mixture is then brought to reaction in an oven at 60° C. for up to 48 hours until a highly viscous liquid is formed.

By repeating these two reaction steps, precursors for bridges with a defined length can be produced.

### Example 5: Biobased Degradation of a Cross-Linked Polysiloxane Using Enzymes

The sample to be tested (prepared according to Examples 1 and 2, but without Aerosil reinforcing agent) is ground to the finest possible powder by means of a mill (PULVERISETTE 7 premium line) using agate-SiO₂ grinding balls of 10 mm diameter.

A defined amount of the sample to be tested is placed in powder form in a sealable plastic vessel. A defined volume of phosphate buffer solution (pH=7.2; Gate Scientific Inc. (2021). Recipes for Phosphate Buffered Saline (PBS). Retrieved 04/05/2022, from https://gatescientific.com/technique-geeks-blog/f/recipes-for-phosphate-buffered-saline-pbs) and a 3% lipase solution (Sigma Aldrich Company; lipase from porcine pancreas, type II, EC number: 3.1.1.3), previously prepared in a separate plastic vessel, were added. The pH value is adjusted to 7.2 to 7.4 with 0.01 M sodium carbonate solution (Sigma Aldrich Company; 0.11 g sodium carbonate in 100 mL double distilled water). The sealed plastic vessel containing the mixture is incubated at 30° C. At the beginning of the degradation test, the powder floats on the aqueous solution (poor wetting). After a few days, a suspension is formed, i.e. the powder is evenly distributed throughout the solution. After further days and weeks, a decrease in the amount of powder in the solution can be observed. This can also be followed gravimetrically, and the residues and filtrates can be examined for degradation using suitable characterization methods.

1. A cross-linked polysiloxanes containing the following general structural feature: 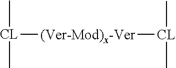
wherein
CL is a so-called “cross-linker” unit, which contains a polysiloxane chain with the basic structure according to formula (I) 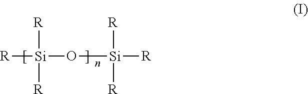
or a polysiloxane ring having the basic structure according to formula (II) 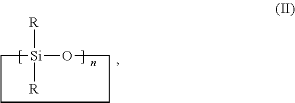
wherein
R is independently selected from a linear, cyclic or branched, aliphatic or aromatic, saturated or unsaturated hydrocarbon group having from 1 to 20 carbon atoms, optionally containing heteroatoms selected from O, N, S or P, —H or —O—R′,
R′ is a polysiloxane chain or a polysiloxane ring having the basic structure according to formula (I) or formula (II), respectively, and
n is a numerical value from 0 to 1000000 in the case of polysiloxane chains according to formula (I), and a numerical value from 2 to 1000000 in the case of polysiloxane rings according to formula (II),
and the precursor of each CL unit contains three or more functional groups that form covalent bonds with terminal functional groups of precursors of bridging groups Ver;
Ver is an organic bridging group whose precursor(s) contain functional groups and/or heteroatoms and at least two terminal functional groups, wherein the at least two terminal functional groups each form a covalent bond with a functional group of a cross-linker precursor or a functional group of a modifier precursor, if present;
Mod are one or more modifier group(s) whose precursor(s) are siloxanes or polysiloxanes containing two terminal functional groups each forming a covalent bond with a terminal functional group of the bridging precursor(s); and
x is a numerical value from 0 to 20.

2. The cross-linked polysiloxanes according to claim 1, wherein the polysiloxane chain according to formula (I) of the cross-linker units CL is selected from the group consisting of poly dimethylsiloxane (PDMS), terminal dihydrogenpolydimethylsiloxane and hydrogenpolydimethylsiloxanes with side groups R═—H.

3. The cross-linked polysiloxanes according to claim 1, wherein the one or more reactive groups of the precursors for the cross-linker units CL is/are selected from the group consisting of —Si—H groups, hydroxy groups, alkoxy groups, carboxy groups, epoxy groups, isocyanate groups and oxime groups.

4. The cross-linked polysiloxanes of claim 1, wherein in the precursor of the organic bridging group(s) Ver, the non-terminal functional groups are selected from the group consisting of esters, imines, ethers, thioethers, ketones, amides, urethanes, thiourethanes and glycosides.

5. The cross-linked polysiloxanes of claim 1, wherein in the precursor of the organic bridging group(s) Ver, the heteroatoms are selected from the group consisting of oxygen, nitrogen, sulfur and phosphorus.

6. The cross-linked polysiloxanes of claim 1, wherein in the precursor of the organic bridging group(s) Ver, the terminal functional groups are independently selected from the group consisting of linear or branched unsaturated hydrocarbon groups having 2 to 10 carbon atoms and terminal C═C double bond, alkoxy groups, carboxy groups and oxime groups.

7. The cross-linked polysiloxanes according to claim 1, wherein the precursor(s) of the bridging group(s) Ver are bio-based, natural product-based or also synthetic.

8. The cross-linked polysiloxanes according claim 1, wherein in the precursor(s) of the modifier group(s) Mod, the terminal functional groups are selected from the group consisting of Si—H groups, hydroxy groups, alkoxy groups, carboxy groups, epoxy groups, isocyanate groups, and oxime groups.

9. The cross-linked polysiloxanes according claim 1, wherein the cross-linked polysiloxanes are comprised in a blend and wherein said blend further comprises fillers, such as particles, fibers, fiber mats, flakes, additives, catalysts and mixtures thereof.

10. The cross-linked polysiloxanes according claim 1, wherein the cross-linked polysiloxanes can be degraded at the organic bridging groups Ver by means of a biobased agent, such as microorganisms, preferably bacteria, fungi or algae, or enzymes outside living organisms.

11. A method for preparing the cross-linked polysiloxanes according claim 1 comprising:
Providing one or more polysiloxanes having polysiloxane chains or polysiloxane rings, which act as a cross-linker unit CL, having the basic structure according to formula (I) or formula (II), respectively;
Providing one or more precursors of the organic bridging group(s) Ver;
Optionally providing one or more precursors of the modifier group(s) Mod;
Optionally covalently linking a terminal functional group of one or more precursors of Ver to a functional group of one or more precursors of Mod in the presence of one or more catalysts and optionally in the presence of one or more inhibitors to produce the optional structure (Ver-Mod)ₓ-Ver;
Covalently linking a respective functional group of the precursor(s) of the cross-linker unit CL, to a respective terminal functional group of the precursor(s) of Ver and/or optionally of (Ver-Mod)ₓ-Ver in the presence of one or more catalysts and optionally in the presence of one or more inhibitors.

12. The method according to claim 11, wherein the catalyst(s) is/are selected from catalysts for hydrosilylation reactions, catalysts for condensation reactions of alkoxy-containing polysiloxanes, catalysts for condensation reactions of carboxy-containing polysiloxanes, and catalysts for condensation reactions of oxime-containing polysiloxanes, preferably precious metal catalysts, more preferably platinum catalysts.

13. A method for biobased degradation of the cross-linked polysiloxanes according claim 1 comprising:
Providing a cross-linked polysiloxane according to claim 1;
Mixing the cross-linked polysiloxane with a biobased agent that cleaves the cross-linked polysiloxane at least at the location of the functional groups and/or heteroatoms of the one or more organic bridging groups Ver.

14. The method according to claim 13, wherein the biobased agent is selected from microorganisms, preferably bacteria, fungi or algae, or enzymes, wherein the enzymes are preferably selected from the group consisting of the major class EC 3.-.-.- of hydrolases, preferably lipases.
